(19) United States
(12) Patent Application Publication
(10) Pub. No.: US 2014/0004765 A1
(43) Pub. Date: Jan. 2, 2014

(54) ADHESIVE TAPE WHICH CAN BE USED, IN PARTICULAR, FOR SECURING DURING TRANSPORTATION

(71) Applicants: Patrick Kerep, Hamburg (DE); Irfan Ertas, Hamburg (DE)

(72) Inventors: Patrick Kerep, Hamburg (DE); Irfan Ertas, Hamburg (DE)

(73) Assignee: TESA SE, Hamburg (DE)

(21) Appl. No.: 13/981,670

(22) PCT Filed: Jan. 20, 2012
(86) PCT No.: PCT/EP12/50837

§ 371 Date: Sep. 10, 2013

(30) Foreign Application Priority Data
Jan. 26, 2011 (DE) 102011009510.1

(51) Int. Cl. C09J 7/04

(52) U.S. Cl. CPC C09J 7/04
USPC 442/149

(57) ABSTRACT

The invention relates to an adhesive tape having a carrier, to which an adhesive compound is applied at least on one side, wherein the carrier consists of a film, on which, on the underside, there is a filament contexture or woven filament fabric which is either applied directly to the film or is joined to the film by means of a laminating adhesive compound, the adhesive compound is applied to that side of the carrier, on which the filament contexture or woven filament fabric is situated, and the filament contexture or woven filament fabric has a tensile strength in the machine direction of at least 50 N/cm and an elongation at break of less than 20%. Said adhesive tape can be used as a transport securing tape for belts which have moveable parts, for example, doors.

This application is a 371 of International Patent Application No. PCT/EP2012/050837, filed Jan. 20, 2012, which claims foreign priority benefit under 35 U.S.C. §119 of the German Patent Application No. 10 2011 009 510.1, filed Jan. 26, 2011.

The invention relates to an adhesive tape which can be used in particular for transit securement.

There are principally three carrier materials employed for transit securement tapes:
MOPP
(drawn) PET
laminates of thin BOPP/PET carriers with glass fibers and PET fibers.

Predominantly in use are oriented carrier materials such as MOPP, for example.

At this point it is also worth mentioning a disadvantage of the increased bond strengths of adhesive transit securement tapes. It is that the increase in bond strengths is accompanied by an increased risk of damage to the substrate on removal, as for example by lifting of surface coatings.

Consequently a need exists for an adhesive transit securement tape which can be employed universally on all application-relevant substrates such as, for example, the plastics ABS, PS, PP, PE, PC, and POM, a variety of metals, and solvent borne, water borne, and powder-applied coating materials.

Despite the fact that adhesive tapes of these kinds are utilized across a great diversity of applications, they have a number of key properties that allow them to fulfill the particular requirements to which they are subject. These properties—without any claim to the completeness of such a list—include very high tensile strength (ultimate tensile force), very good resistance to stretching, corresponding to a high modulus at low stretch, and a low elongation at break, a sufficient but not excessive bond strength, a controlled bond strength to their own reverse face, the possibility of redetachment without residue after the exposures involved in the application itself, the robustness of the carrier under mechanical load, and also, for certain applications, the resistance of the adhesive tape toward UV irradiation and with respect to numerous chemicals.

While certain of the properties can be traced to the adhesive or other functional layers of the adhesive masking tape, the stretchability and tensile strength derive substantially from the physical properties of the carrier material used.

Generally speaking, oriented film carriers are used for adhesive transit securement tapes, on account of the particular mechanical demands. Through orientation, which equates to the stretching of the primary film, formed primarily in the production operation, in one or more preferential directions, it is possible to exert controlled influence over the mechanical properties. So-called biaxially oriented films can on the one hand be stretched sequentially, with the primary film, after having been formed by extrusion with a slot die, being first stretched in machine direction, by being passed over a sequence of rolls, the transport rate of the film being greater than the rate of emergence from the extrusion die. The film is subsequently stretched in the transverse or cross direction in a drawing unit. The stretching of the film in two directions can also be performed in one step (compare, for example, U.S. Pat. No. 4,675,582 A and U.S. Pat. No. 5,072,493 A).

Likewise present in the adhesive tapes market are tapes whose BOPP carriers have been stretched in the blown film process.

In one preferred embodiment, carriers for adhesive transit securement tapes are stretched exclusively in machine direction. With this method it is possible to obtain polypropylene films having the highest tensile strengths and moduli. The draw ratio used, this being the ratio of the length of a primary film compartment to the corresponding compartment in the end product, is typically between 1:5 to 1:10. Particularly preferred are draw ratios of between 1:7 and 1:8.5. The very high stretch resistance of polypropylene films which have been oriented exclusively monoaxially is one of the most important properties for their use.

The principle of action of the orientation process lies in the alignment of the polymer molecule chains and of the crystal structures they form, and also in the alignment of the amorphous regions into specific preferential directions, and the associated increase in strength. In principle, however, the strength is also reduced in the direction in which no orientation takes place. Accordingly, in the case of the BOPP and BOPET films, and most especially in the case of the MOPP films, there is a significantly lower strength of the films in the z-direction (in the direction of least extent of the film).

In summary, the properties imposed on a transit securement tape are as follows:
a) Good bonding:
   The adhesive tape must adhere sufficiently to a variety of substrates and possess cohesion sufficiently to secure movable parts during transit.
b) High tensile strength:
   The adhesive tape must have sufficient strength to secure moving parts, especially relatively heavy moving parts, without tearing.
c) Low stretchability:
   The adhesive tape must have low stretch, in order not to yield during securement of relatively heavy articles.
d) Residue-free removability:
   The adhesive tape must be able to be removed from the substrate without residue.
e) Impact toughness in cross direction:
   The adhesive tape, depending on the nature of the application, must also be able to absorb load in the cross direction that may come about by shock exposure of the product in transit.
f) Stability in the event of edge damage:
   The adhesive tape must retain its functionality even if the edge becomes damaged.

Among the disadvantages of conventional MOPP and drawn PET are that they have a high stretchability of greater than 25% to 30% and therefore yield significantly under load. As a result of this stretch, the transit product secured with an adhesive tape of this kind may become loose, and is no longer sufficiently secured.

A further disadvantage of MOPP and of drawn PET is that they tear right through very easily if the edge becomes damaged. Since typical applications include the requirement to secure articles having sharp edges, the adhesive tape can easily be damaged in this case, and tear.

Yet another disadvantage of BOPP and MOPP is that they are easily fragmented in machine direction in the event of exposure to shock in the cross direction; that is, they have low tensile impact toughness. In many cases, however, the adhesive tapes are adhered in the longitudinal direction over a gap (for example, refrigerator door). During transit, high forces may act in transverse direction on the adhesive tape, causing them to tear apart in the longitudinal direction. The function as transit securement is hence no longer ensured.

To obtain some improvement, carriers made from drawn PET or BOPP are reinforced with glass fiber filaments. The filaments give the adhesive tape a high tensile strength and at the same time have low stretchability. If the edge becomes damaged, the carrier does tear, but the filaments do not.

A general disadvantage of glass filaments is their high fragility. This means that the adhesive tapes lose their tensile strength to some extent, or even entirely, if they pass over sharp edges, since the glass filaments become broken.

Conventional PET filaments are not fragile, afford good tensile strength, but have a stretchability of greater than 25% and are therefore of only limited suitability.

All unidirectional reinforcements do not give the adhesive tape any tensile strength in cross direction, meaning that the above-described disadvantage associated, for example, with application to a (door) gap is still present. Tensile strength and tensile impact toughness in cross direction are not improved.

The adhesive tape, moreover, ought to be detachable without residue, since the products secured are subsequently sold and are required to meet appearance demands. During the detachment operation, tapes with unidirectional reinforcement often leave behind residues, as shown in FIG. 1.

### BRIEF DESCRIPTION OF THE DRAWINGS

FIG. 1 shows, during a detachment operation, tapes with unidirectional reinforcement leaving behind residues;

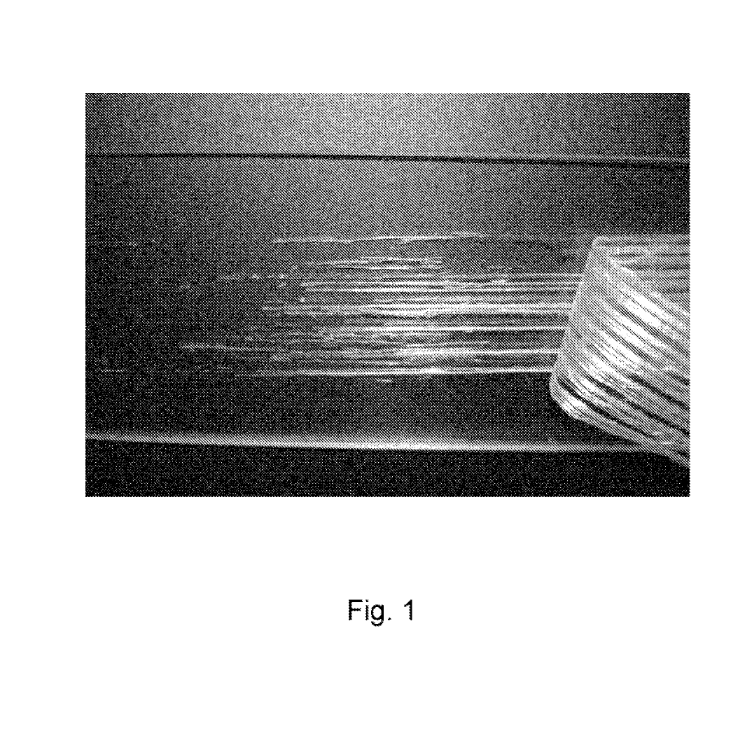

FIG. 2 shows how the adhesive tape of the invention can be redetached without residue;

FIG. 3 shows a construction for measuring the strength in the cross direction;

FIG. 4 shows the construction according to FIG. 3 from the side;

FIG. 5 shows the inventive adhesive tape in a side section, consisting of a carrier 11 bearing on one side an applied layer of a self-adhesive coating 12; and

FIG. 6 is a comparison of the cross direction strength of an adhesive tape of the invention (on the right, labeled “tesa”) and of a known adhesive tape (on the left, labeled “competitor”).

it is an object of the invention to obtain a marked improvement over the prior art and to provide an adhesive tape which exhibits high strength and low stretchability and that in particular is also redetachable from the substrate without residue.

This object is achieved by means of an adhesive tape as characterized more closely in the main claim. The dependent claims describe advantageous embodiments of the invention. Likewise encompassed by the concept of the invention is the use of the tape of the invention.

The invention accordingly provides an adhesive tape having a carrier bearing on at least one side an applied adhesive, where
the carrier consists of a film having on its underside a laid or woven filament fabric which has either been applied directly to the film or been joined to the film by means of a laminating adhesive,
the adhesive is applied to the side of the carrier on which the laid or woven filament fabric is located, and
the laid or woven filament fabric has a tensile strength in machine direction of at least 50 N/cm and also an elongation at break of below 20%, preferably below 15%, more preferably below 10%.

According to one preferred embodiment, the film consists
of mono- or biaxially oriented polypropylene,
of mono- or biaxially oriented polyethylene, or
of mono- or biaxially oriented polyester.

Also suitable as film material are films such as PA, PU, or PVC, for example. The films themselves may in turn consist of a plurality of individual plies, such as plies coextruded to form film, for example.

Polyolefins are preferred, although copolymers of ethylene and polar monomers such as styrene, vinyl acetate, methyl methacrylate, butyl acrylate or acrylic acid are also included. A homopolymer such as HDPE, LDPE, or MDPE, or a copolymer of ethylene with a further olefin such as propene, butene, hexene, or octene (for example LLDPE, VLLDPE) is possible. Also suitable are polypropylenes (for example, polypropylene homopolymers, polypropylene random copolymers, or polypropylene block copolymers).

As films in accordance with the invention it is possible with outstanding effect to use monoaxially and biaxially oriented films. Monoaxially oriented polypropylene, for example, is notable for its very high tear strength and low stretch in longitudinal direction.

Particularly preferred are films based on polyester.

The film preferably has a thickness of 12 μm to 100 μm, more preferably 28 to 50 μm, more particularly 35 μm.

The film may be colored and/or transparent.

According to a further advantageous embodiment, the laid or woven filament fabric is a warp knit with weft threads (weft inserted warp knit). A fabric of this kind is described for example in EP 1 818 437 A1.

The laid or woven filament fabric has a tensile strength in machine direction of preferably at least 100 N/cm, more preferably 200 N/cm, very preferably 500 N/cm.

The yarns used to form the laid or woven fabric preferably have a strength of 80 to 2200 dtex, preferably 2800 to 1100 dtex.

For the purposes of this invention, a filament means a bundle of parallel, linear individual fibers/filaments, often referred to in the literature also as multifilament. Optionally it is possible for this fiber bundle to be strengthened inherently by twisting, the resulting filaments then said to be spun or twisted filaments. An alternative possibility for providing the fiber bundle with inherent strengthening is by entanglement using compressed air or a water jet. In the text below, as a general term for all of these embodiments, “filament” is simply used.

The filament may be textured or smooth and have point consolidation or no consolidation.

The laid/woven fabric may have been subsequently colored or may consist of spun dyed yarns.

With further preference the filaments consist of polyester, polypropylene, polyethylene, or polyamide, preferably polyester (diols).

According to a further advantageous embodiment of the invention, the filament count in warp direction is at least 6/cm, preferably 10 to 25/cm, and/or the filament count in the weft is at least 3 to 10/cm, preferably 6/cm.

To produce an adhesive tape in the carrier it is possible to employ all known adhesive systems. As well as natural or synthetic rubber based adhesives it is possible in particular to use silicone adhesives and also polyacrylate adhesives, preferably a low molecular mass, pressure-sensitive, acrylate hotmelt adhesive. The latter are described in DE 198 07 752 A1 and also in DE 100 11 788 A1 in more detail.

The laminating adhesive, where present, may be selected from the same adhesive systems.

The application weight ranges preferably between 15 to 200 g/m², more preferably 30 to 120 g/m², very preferably 80 g/m² (corresponding approximately to a thickness of 15 to 200 μm, more preferably 30 to 120 μm, very preferably 80 μm).

The adhesive is preferably a pressure-sensitive adhesive—that is, a viscoelastic composition which in the dry state at room temperature remains permanently tacky and adhesive. Bonding is accomplished under gentle applied pressure instantaneously to virtually all substrates.

Pressure-sensitive adhesives employed include those based on block copolymers containing polymer blocks. These blocks are formed preferably of vinylaromatics (A blocks) such as styrene, for example, and those through polymerization of 1,3-dienes (B blocks), such as, for example, butadiene and isoprene or a copolymer of the two. Mixtures of different block copolymers can also be employed. Preference is given to using products which are partly or fully hydrogenated.

The block copolymers may have a linear A-B-A structure. It is likewise possible to employ block copolymers with radial architecture, and also star-shaped and linear multiblock copolymers.

In place of the polystyrene blocks it is also possible to utilize polymer blocks based on other aromatics-containing homopolymers and copolymers (preferably C₈ to C₁₂ aromatics), having glass transition temperatures of >about 75° C., such as, for example, α-methylstyrene-containing aromatics blocks. Also utilizable are polymer blocks based on (meth)acrylate homopolymers and (meth)acrylate copolymers with glass transition temperatures of >+75° C. In this context it is possible to employ not only block copolymers which as hard blocks utilize exclusively those based on (meth)acrylate polymers, but also those which utilize not only polyaromatics blocks, polystyrene blocks for example, but also poly(meth)acrylate blocks.

The figures for the glass transition temperature for materials which are not inorganic and not predominantly inorganic, more particularly for organic and polymeric materials, relate to the glass transition temperature figure T_{g} in accordance with DIN 53765:1994-03 (cf. section 2.2.1), unless indicated otherwise in the specific case.

In place of styrene-butadiene block copolymers and styrene-isoprene block copolymers and/or their hydrogenation products, including styrene-ethylene/butylene block copolymers and styrene-ethylene/propylene block copolymers, it is likewise possible in accordance with the invention to utilize block copolymers and their hydrogenation products which utilize further polydiene-containing elastomer blocks such as, for example, copolymers of two or more different 1,3-dienes. Further utilizable in accordance with the invention are functionalized block copolymers such as, for example, maleic anhydride-modified or silane-modified styrene block copolymers.

Typical use concentrations for the block copolymer lie at a concentration in the range between 30 wt % and 70 wt %, more particularly in the range between 35 wt % and 55 wt %.

Further polymers that may be present are those based on pure hydrocarbons such as, for example, unsaturated polydienes, such as natural or synthetically produced polyisoprene or polybutadiene, elastomers with substantial chemical saturation, such as, for example, saturated ethylene-propylene copolymers, α-olefin copolymers, polyisobutylene, butyl rubber, ethylene-propylene rubber, and also chemically functionalized hydrocarbons such as, for example, halogen-containing, acrylate-containing, or vinyl ether-containing polyolefins, which may replace up to half of the vinylaromatics-containing block copolymers.

Serving as tackifiers are tackifier resins.

Suitable tackifier resins include preferably partially or fully hydrogenated resins based on rosin or on rosin derivatives. It is also possible at least in part to employ hydrogenated hydrocarbon resins, examples being hydrogenated hydrocarbon resins obtained by partial or complete hydrogenation of aromatics-containing hydrocarbon resins (for example, Arkon P and Arkon M series from Arakawa, or Regalite series from Eastman), hydrocarbon resins based on hydrogenated dicyclopentadiene polymers (for example, Escorez 5300 series from Exxon), hydrocarbon resins based on hydrogenated C₅/C₉ resins (Escorez 5600 series from Exxon), or hydrocarbon resins based on hydrogenated C₅ resins (Eastotac from Eastman), and/or mixtures thereof.

Hydrogenated polyterpene resins based on polyterpenes can also be used. Aforementioned tackifier resins may be employed both alone and in a mixture.

Further additives that can be used include typically light stabilizers such as, for example, UV absorbers, sterically hindered amines, antiozonants, metal deactivators, processing assistants, and endblock-reinforcing resins.

Plasticizers such as, for example, liquid resins, plasticizer oils, or low molecular mass liquid polymers such as, for example, low molecular mass polyisobutylenes with molar masses<1500 g/mol (numerical average) or liquid EPDM grades are typically employed.

The adhesive may be applied in the longitudinal direction of the adhesive tape in the form of a strip whose width is lower than that of the carrier of the adhesive tape.

The coated strip may have a width of 10% to 80% of the width of the carrier material. In a case of this kind there is particular preference in using strips with a coating of 20% to 50% of the width of the carrier material.

Depending on the specific utility, it is also possible for two or more parallel strips of the adhesive to be coated on the carrier material.

The length of the strip on the carrier is freely selectable, with an arrangement directly at one of the edges of the carrier being preferred.

Lastly, the adhesive tape may have a liner material, with which the one or two layers of adhesive are lined up until use. Suitable liner materials include all of the materials listed comprehensively above.

Preference, however, is given to using a nonlinting material such as a polymeric film or a well-sized, long-fiber paper.

Production and processing of the adhesives may take place from solution, from dispersion, and from the melt. Preferred production and processing procedures take place from solution and from the melt. Particularly preferred is the manufacture of the adhesive from the melt, in which case batch methods or continuous methods may be employed in particular. Particularly advantageous is the continuous manufacture of the pressure-sensitive adhesives with the aid of an extruder.

Processing from the melt may encompass application methods via a die or a calender.

Processes from solution that are known include coating operations using doctor blades, knives, or dies, to name but a few.

A release agent may have been applied to the top face of the carrier or film.

Suitable release agents include surfactant-based release systems based on long-chain alkyl groups such as stearyl sulfosuccinates or stearyl sulfosuccinamates, but also polymers, which may be selected from the group consisting of polyvinylstearyl carbamates, polyethyleneimine stearylcarbamides, chromium complexes of C₁₄-C₂₈ fatty acids, and stearyl copolymers, as described for example in DE 28 45 541 A. Likewise suitable are release agents based on acrylic polymers with perfluorinated alkyl groups, silicones or fluorosilicone compounds, such as those based on poly(dimethylsiloxanes), for example. With particular preference the release coat comprises a silicone-based polymer. Particularly preferred examples of such silicone-based polymers with release effect include polyurethane- and/or polyurea-modified silicones, preferably organopolysiloxane/polyurea/polyurethane block copolymers, more preferably those as described in example 19 of EP 1 336 683 B1, very preferably anionically stabilized, polyurethane- and urea-modified silicones having a silicone weight fraction of 70% and an acid number of 30 mg KOH/g. An effect of using polyurethane- and/or urea-modified silicones is that the products of the invention combine optimized aging resistance and universal writability with an optimized release behavior. in one preferred embodiment of the invention, the release layer comprises 10 to 20 wt %, more preferably 13 to 18 wt %, of the release-effect constituent.

The general expression “adhesive tape” in the context of this invention encompasses all sheetlike structures such as two-dimensionally extended films or film sections, tapes with extended length and limited width, tape sections and the like, and also diecuts or labels.

The adhesive tape may be produced in the form of a roll, in other words in the form of an Archimedean spiral wound up onto itself, or with lining with release materials such as siliconized paper or siliconized film on the adhesive side.

The reverse face of the adhesive tape may carry an applied reverse-face varnish, in order to beneficially influence the unwind properties of the adhesive tape wound into an Archimedean spiral.

The use of reinforcements consisting of bidirectional laid/woven fabrics made from PET yarns with low stretchability has proven advantageous. In particular, warp knits with weft threads are suitable, since the lack of the corrugated structure of the warp thread in the case of laid fabrics means that no additional stretchability is introduced into the material.

Surprisingly, for a given adhesive and coatweight, an additional property of the bidirectionally reinforced adhesive tapes is a significant improvement in residue-free detachability from the substrate. As a result, the extraction of fibers during the detachment operation is significantly reduced or even eliminated entirely. Moreover, the adhesive tape acquires a high strength and tensile impact toughness in cross direction, and at the same time a significantly reduced fragility relative to glass.

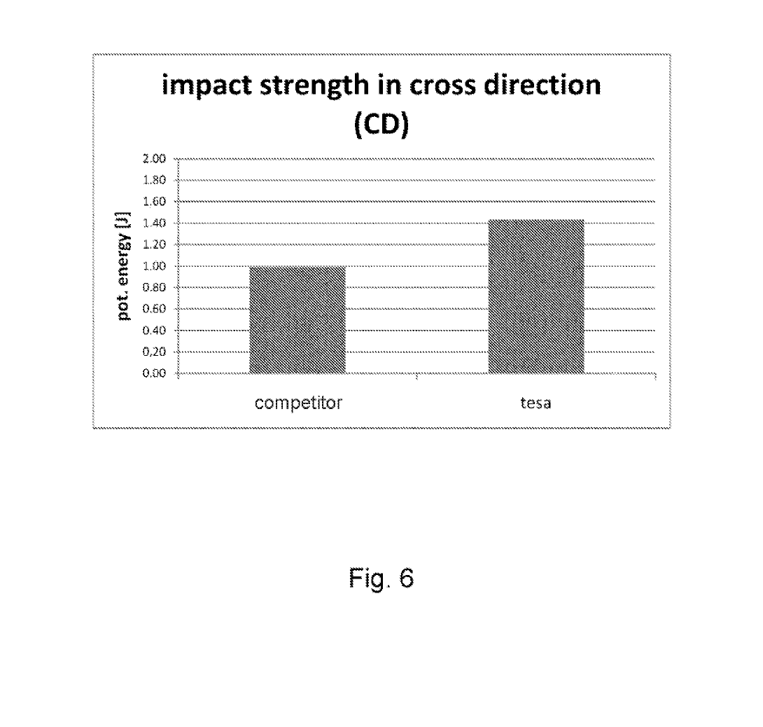

Shown in FIG. 6 is a comparison of the cross direction strength of an adhesive tape of the invention (on the right, labeled “tesa”) and of a known adhesive tape (on the left, labeled “competitor”), the latter having only unidirectional reinforcement in the longitudinal direction, in the form of pure filaments,

The construction of the adhesive tapes is that indicated in table 1:

TABLE 1

| Carrier | 50 μm PET film | 36 μm PET film |
|---|---|---|
| Reinforcement | unidirectional | bidirectional |
| | PET fibers | PET fibers |
| Longitudinal direction | 335 dtex | 1100 dtex |
| | 11 filaments/cm | 7.3 filaments/cm |
| Cross direction | ./. | 167 |
| | ./. | 3.6 filaments/cm |
| Adhesive | NR | SR |
| Pot. energy [J] | 0.988 | 1.429 |

“NR” stands for a natural rubber based adhesive
“SR” stands for a synthetic rubber based adhesive

The potential energy can be calculated from the drop height (H) and the weight (m):

W=m*g*H in [J]

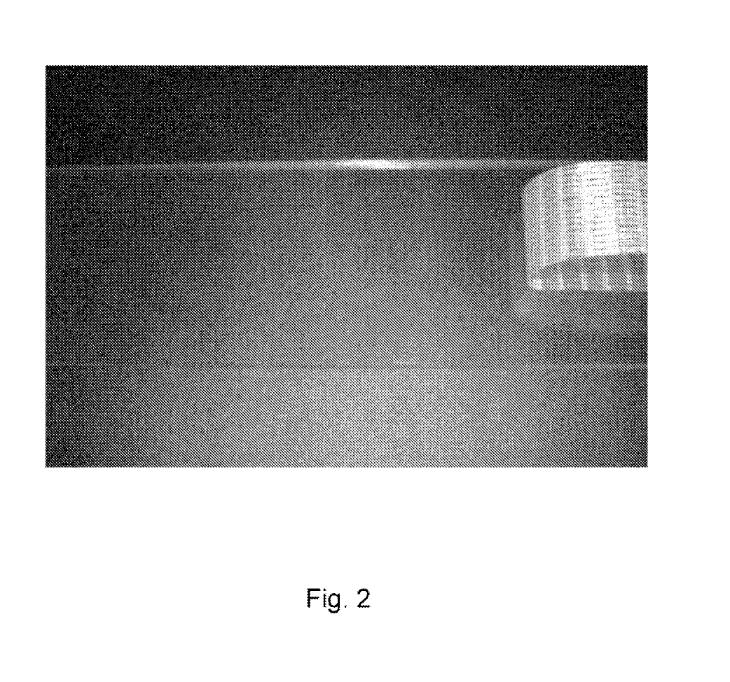

FIG. 2 shows how the adhesive tape of the invention can be redetached without residue.

### Test Methods

Unless the standard referred to describes something different, the measurements are conducted under test conditions of 23±1° C. and 50±5% relative humidity.

The ultimate tensile force (tensile strength) is measured according to AFERA 5004, the elongation at break to AFERA 5005, and the bond strength to AFERA 4001.

### Residue-Free Removability from Plastics Surfaces

To test the residue-free removability of the adhesive tape from plastics surfaces, adhesive tape strips 20 mm wide are bonded to plastics panels (made of polycarbonate, for example) and rolled on using a weight (2 kg, 3 m/min.).

The specimens are stored in the bonded state prior to testing for three days at 40° C. and then conditioned at room temperature for one day.

In the test for its ability to be taken up again, the first half of the adhesive tape strip is peeled from the substrate at an angle of 90°, and a determination is made of the residue.

The second half of the strip is then peeled at an angle of 180°, and a determination is made of the residue. The peel speed in each case is 20 m/min.

### Measurement of the Cross Direction Strength

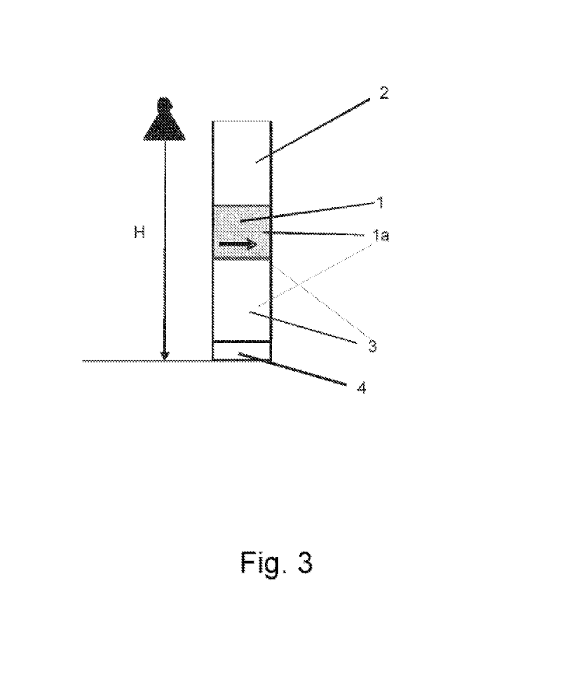

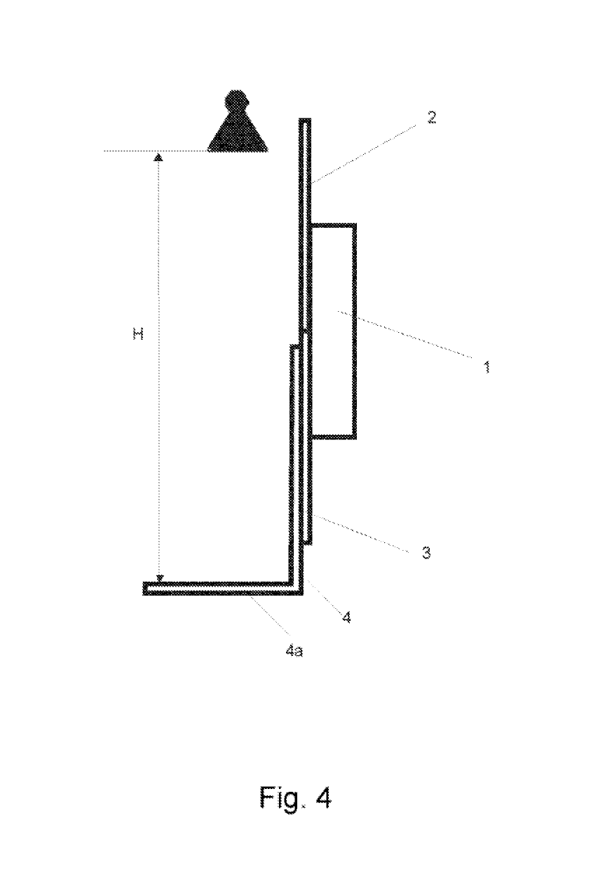

The strength in the cross direction is measured in accordance with a construction like that shown by FIGS. 3 and 4. FIG. 4 shows the construction according to FIG. 3 from the side.

Two plastics test panels 2 and 3, one on top of the other, are overstuck at the point of abutment with a 50 mm wide adhesive tape 1, so that the abutment 1a is located centrally. The abutment runs in the machine direction of the adhesive tape (indicated by the arrow). The width of the panels (corresponding to the length of the adhesive tape strip) is 50 mm.

This prepared specimen is clamped onto an apparatus (not shown in detail). In the apparatus, the upper plastics panel 2 is applied firmly and the bottom panel, 3, is mounted on a carriage 4 which can be moved downward. In its rear part, the carriage 4 has a 90° steel angle 4a, onto which a weight can be dropped. The weight weighs 400 g and is dropped from the prescribed drop height H onto the 90° angle 4a of the carriage 4.

The maximum drop height H is limited to 500 mm.

The weight is dropped from a defined height H onto the angle 4a.

The observed height H at which the adhesive tape fragments in the direction of weight drop, is correlated with the strength (impact toughness) of the tape in cross direction.

In the text below, the adhesive tape is to be elucidated in more detail with reference to a figure, without wishing to bring about any kind of restriction at all.

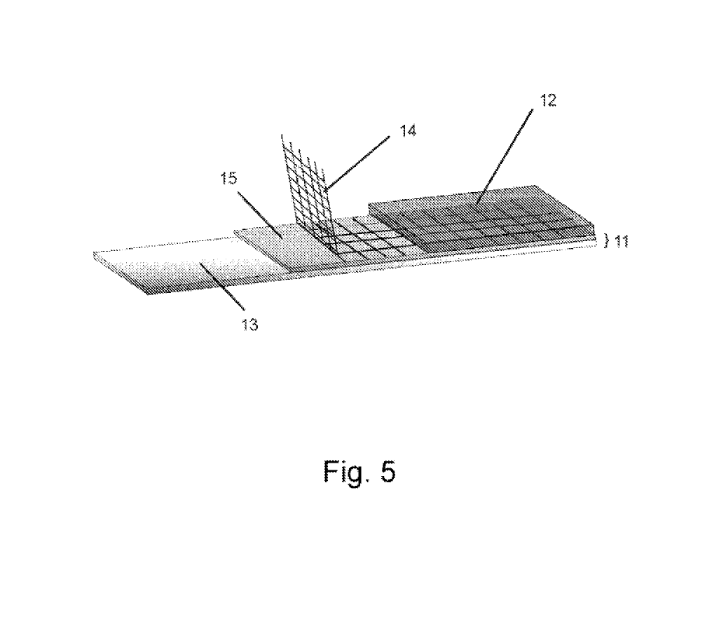

Shown in FIG. 5 in a side section is the adhesive tape, consisting of a carrier 11 bearing on one side an applied layer of a self-adhesive coating 12.

Laminated on a PET film 13 which is 35 μm thick is a WIWK (weft inserted warp knit) fabric made of PET (diols) 14, using a laminating adhesive 15. Coated onto the WIWK fabric 14 is an adhesive 12 based on SIS, at 80 g/m², with a bond strength of 7.5 N/cm.

1. An adhesive tape having a carrier bearing on at least one side an applied adhesive, where
the carrier consists of a film having on its underside a laid or woven filament fabric which has either been applied directly to the film or been joined to the film by means of a laminating adhesive,
the adhesive is applied to the side of the carrier on which the laid or woven filament fabric is located, and
the laid or woven filament fabric has a tensile strength in a machine direction of at least 50 N/cm and also an elongation at break of below 20%.

2. The adhesive tape of claim 1,
wherein
the film consists
of mono- or biaxially oriented polypropylene,
of mono- or biaxially oriented polyethylene, or
of mono- or biaxially oriented polyester.

3. The adhesive tape of claim 1,
wherein
the film has a thickness of 12 μm to 100 μm.

4. The adhesive tape of claim 1,
wherein
the laid or woven filament fabric is a warp knit with weft threads (weft inserted warp knit).

5. The adhesive tape of claim 1,
wherein
the laid or woven filament fabric has a tensile strength in machine direction of at least 100 N/cm.

6. Method of using the adhesive tape of claim 1 as a transit securement tape for goods having movable parts.
